(19) United States
(12) Patent Application Publication
(10) Pub. No.: US 2026/0322087 A1
(43) Pub. Date: Oct. 15, 2026

(54) ELECTRICAL OUTLET COVER

(71) Applicant: Jimmie Case, El Reno, OK (US)

(72) Inventor: Jimmie Case, El Reno, OK (US)

(21) Appl. No.: 19/174,484

(22) Filed: Apr. 9, 2025

(51) Int. Cl. H02G 3/08

(52) U.S. Cl. CPC H02G 3/081

(57) ABSTRACT

An electrical outlet covering apparatus for covering a portion of an electrical cord which extends from an electrical outlet to a floor surface includes an enclosure which extends over the electrical outlet. An outlet bracket is coupled to the enclosure and is designed to mount the enclosure to the electrical outlet via inserting a screw through a mounting hole in the outlet bracket and into an outlet mount hole of the electrical outlet. The outlet bracket is positioned relative to a bottom of the enclosure such that the bottom of the enclosure is configured to retain a portion of an electrical cord plugged into the electrical outlet adjacent to a floor surface when the outlet bracket is mounted to the electrical outlet.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to outlet covering apparatuses and more particularly pertains to a new outlet covering apparatus for covering a portion of an electrical cord which extends from an electrical outlet to a floor surface.

### (2) Description of Related Art Including Information Disclosed Under 37 CFR 1.97 and 1.98

The prior art describes myriad outlet cover apparatuses but does not disclose an outlet cover apparatus which is designed to retain a portion of an electrical cord near a floor surface under the electrical outlet when the electrical cord is plugged into the electrical outlet.

### (h) Brief Summary of the Invention

An embodiment of the disclosure meets the needs presented above by generally comprising an enclosure which has a front wall, a top wall, and a pair of lateral walls. The top wall and the pair of lateral walls are coupled to and extend rearwardly from the front wall. The top wall is coupled to and extends between the pair of lateral walls. The enclosure has a cavity defined by the front wall, the top wall, and the pair of lateral walls. An outlet bracket is coupled to the enclosure and is configured to mount to an electrical outlet. The outlet bracket is positioned in the cavity of the enclosure and comprises a back panel which extends between the pair of lateral walls of the enclosure. The back panel has a mounting hole which extends therethrough and is positioned to facilitate mounting the outlet bracket to the electrical outlet via an outlet-mounting threaded fastener which extends through the mounting hole of the back plate and an outlet mount hole of the electrical outlet. The outlet bracket is positioned relative to a bottom of the enclosure such that the bottom of the enclosure is configured to retain a portion of an electrical cord plugged into the electrical outlet adjacent to a floor surface when the outlet bracket is mounted to the electrical outlet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an enclosure of an electrical outlet covering apparatus according to an embodiment of the disclosure.

FIG. 2 is a back view of an enclosure of an embodiment of the disclosure.

FIG. 3 is a side view of an enclosure of an embodiment of the disclosure.

FIG. 4 is a front view of an outlet bracket of an embodiment of the disclosure.

FIG. 5 is a back view of an outlet bracket of an embodiment of the disclosure.

FIG. 6 is a side view of an outlet bracket of an embodiment of the disclosure.

FIG. 7 is a front view of an embodiment of the disclosure in which surface details of an enclosure have been removed to show an alignment of an outlet bracket and an electrical outlet to the enclosure.

FIG. 8 is an in-use view of an embodiment of the disclosure.

### (j) DETAILED DESCRIPTION OF THE INVENTION

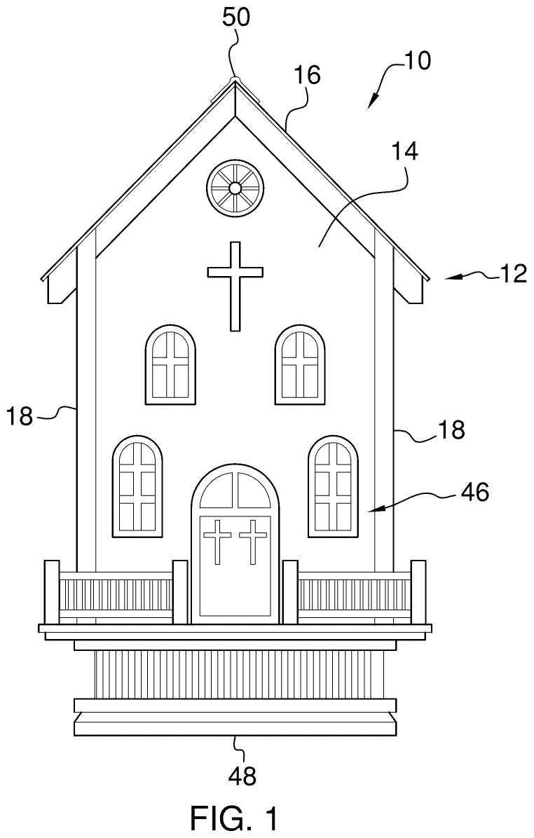

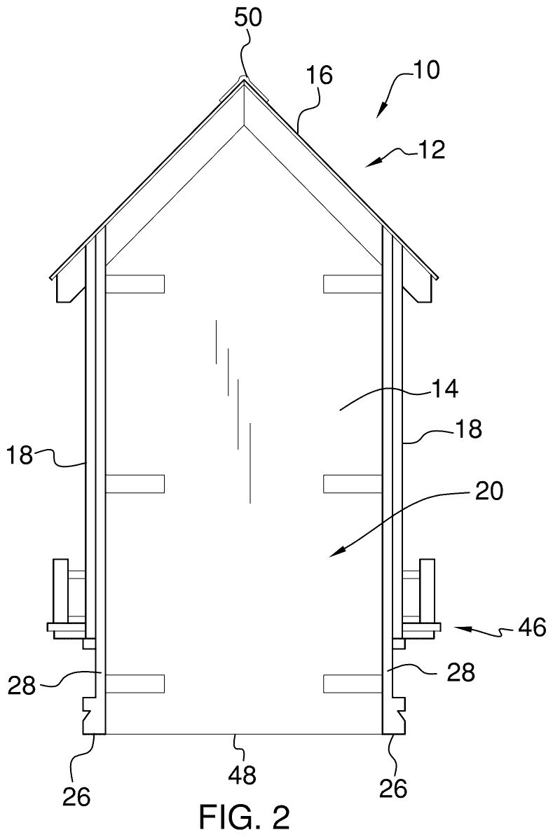

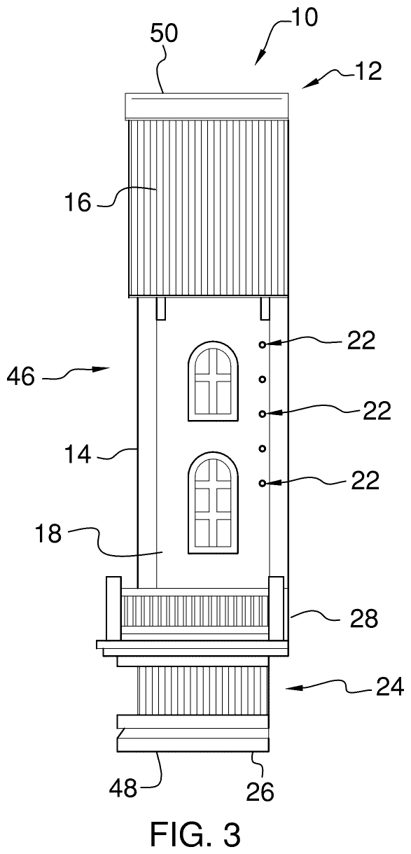

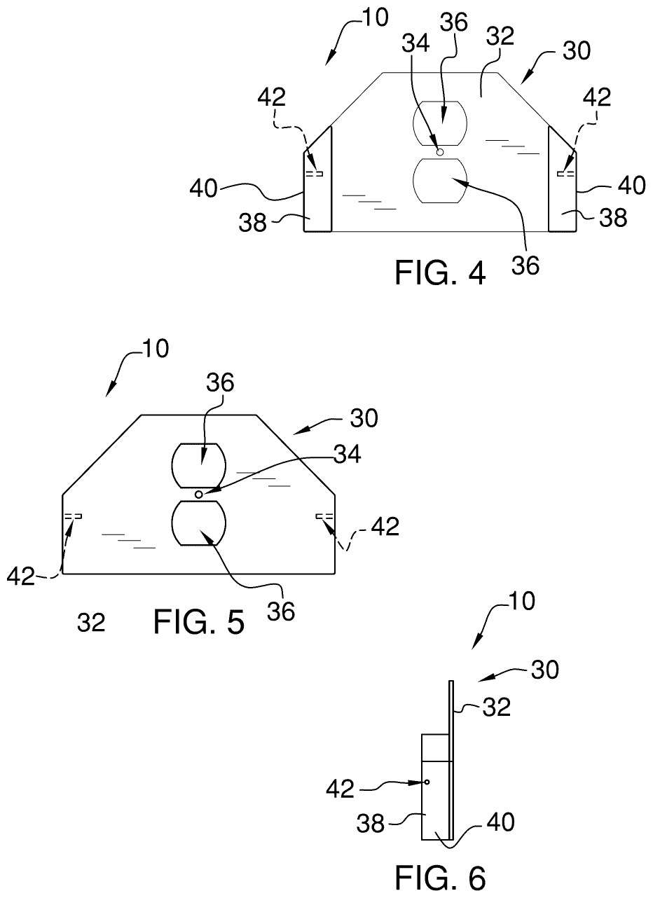

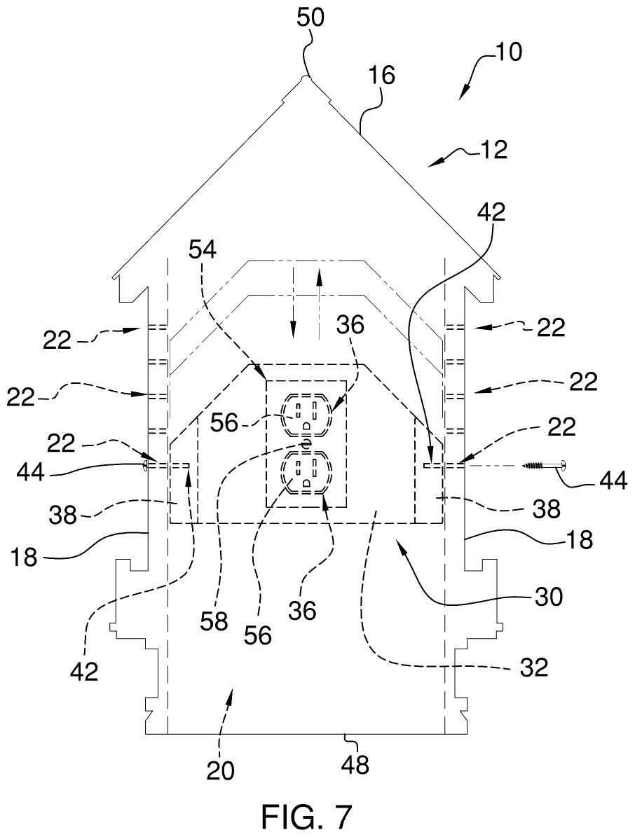

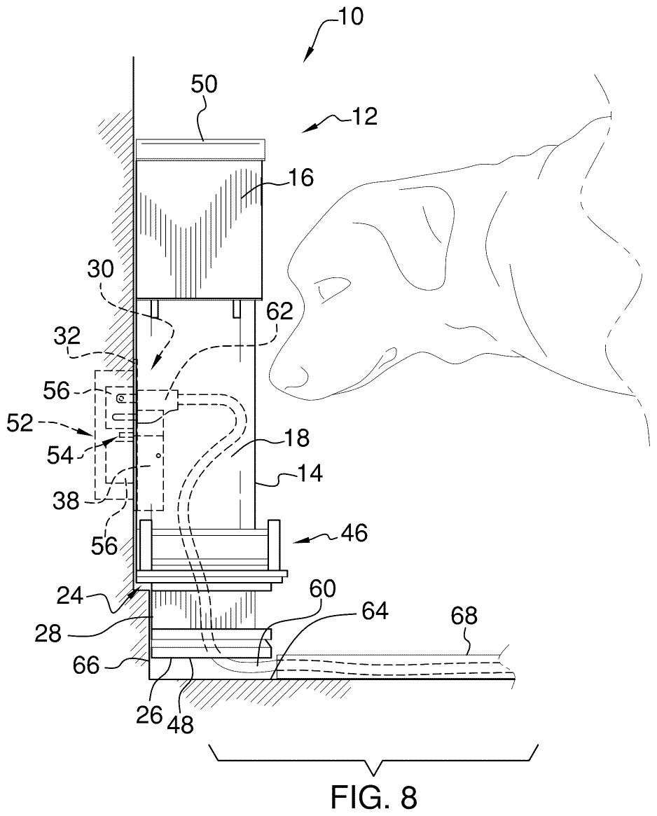

With reference now to the drawings, and in particular to FIGS. 1 through 8 thereof, a new outlet covering apparatus embodying the principles and concepts of an embodiment of the disclosure and generally designated by the reference numeral 10 will be described.

As best illustrated in FIGS. 1 through 8, the electrical outlet covering apparatus 10 generally comprises an enclosure 12 which has a front wall 14, a top wall 16, and a pair of lateral walls 18. The top wall 16 and the pair of lateral walls 18 are coupled to and extend rearwardly from the front wall 14. The top wall 16 is coupled to and extends between the pair of lateral walls 18. The enclosure 12 has a cavity 20 which is defined by the front wall 14, the top wall 16, and the pair of lateral walls 18. Each lateral wall 18 of the pair of lateral walls 18 has a plurality of height adjustment slots 22 extending therethrough. The height adjustment slots 22 of each lateral wall 18 are spaced from each other between a top 50 of the enclosure 12 and a bottom 48 of the enclosure 12. Each lateral wall 18 of the pair of lateral walls 18 has a notch 24 at a corner of a bottom edge 26 and a back edge 28 of the lateral wall 18 which is sized and shaped to accommodate a baseboard 66.

An outlet bracket 30 is couplable to the enclosure 12 and to an electrical outlet 52 such that the enclosure 12 extends over the electrical outlet 52 and may accommodate a plug 62 of an electrical cord 60 in the cavity 20. The outlet bracket 30 is positioned in the cavity 20 of the enclosure 12 and comprises a back panel 32 which extends between the pair of lateral walls 18 of the enclosure 12. The back panel 32 has a mounting hole 34 which extends through the back panel 32 and is positioned to receive an outlet-mounting threaded fastener 58 which may be screwed into an outlet mount hole 54 of the electrical outlet 52 to secure the outlet bracket 30 to the electrical outlet 52. The outlet-mounting threaded fastener 58 may be equivalent to a face plate screw for attaching a face plate to the electrical outlet 52. The back panel 32 also has a pair of outlet access holes 36 which extends therethrough. Each outlet access hole 36 is positioned to align with an associated receptacle 56 of a pair of receptacles 56 of the electrical outlet 52 when the outlet bracket 30 is mounted to the electrical outlet 52 and may receive the plug 62 of the electrical cord 60 such that the plug 62 may insert into one of the receptacles 56. The mounting hole 34 is positioned between the pair of outlet access holes 36.

It should be noted that while “outlet” and “receptacle” are often used interchangeably with each other in regular parlance, for the purposes of this disclosure “electrical outlet” refers to the entire electrical assembly by which one or more electrical plugs may electrically couple to an electrical power source such as an electric utility. Additionally, “receptacle” is used in this disclosure to refer to a subassembly of an electrical outlet 52 for receiving a single electrical plug. The electrical outlet 52 shown in the figures is a duplex electrical outlet which comprises two receptacles 56. In other embodiments, a different number of receptacles 56 and the outlet mount hole 54 may be positioned differently relative to the receptacles 56.

The outlet bracket 30 further comprises a pair of lateral members 38 coupled to the back plate. The lateral members 38 are positioned opposite each other across the mounting hole 34, and each lateral member 38 couples to an associated lateral wall 18 of the pair of lateral walls 18 of the enclosure 12. Each lateral member 38 has a fastener slot 42 which extends through an outer surface 40 of the lateral member 38 and may be positioned to interchangeably align with each height adjustment slot 22 of the associated lateral wall 18.

A pair of height adjustment fasteners 44 is provided to removably couple the outlet bracket 30 to the enclosure 12. Each height adjustment fastener 44 extends through a selected height adjustment slot 22 of an associated lateral wall 18 of the pair of lateral walls 18 of the enclosure 12 and the fastener slot 42 of an associated lateral member 38 of the pair of lateral members 38 of the outlet bracket 30. Each height adjustment fastener 44 comprises a threaded fastener such as a screw or a bolt but may comprise a pin or the like. In other embodiments, the outlet bracket 30 may be releasably mountable to the enclosure 12 via a clamp, a latch, a snap fit connector, or the like.

A decorative element 46 covers an entirety of the exterior of the enclosure 12. The decorative element 46 comprises a three-dimensional representation which resembles a façade of a church. In other embodiments, the decorative element 46 may be a model of another structure such as a barn, a fireplace, a house, or the like.

In use, the enclosure 12 may be mounted to the electrical outlet 52 to cover a portion of the electrical cord 60 which extends from the electrical outlet 52 to a floor surface 64 and guide the electrical cord 60 under the bottom 48 of the enclosure 12 adjacent to the floor surface 64. A conventional cord covering apparatus 68 may then be used to cover the portion of the electrical cord 60 which extends across the floor surface 64. By covering the portion of the electrical cord 60 which extends from the electrical outlet 52 to the floor surface 64, the enclosure 12 protects the cord from interference by pets, children, or others. The enclosure 12 also protects the pets from being shocked due to damaging the cord.

The enclosure 12 also provides decoration. The positioning of the bottom 48 of the enclosure 12 near the floor surface 64 may also provide an illusion that the enclosure 12 is supported by the floor surface 64. This is especially true when positioning the enclosure 12 over a carpet or a rug with a tall nap. In such use cases, the cord may lie under the tops of fibers of the carpet while the bottom 48 of the enclosure 12 is positioned adjacently above the tops of the fibers.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electrical outlet covering apparatus comprising:
an enclosure having a front wall, a top wall, and a pair of lateral walls, the top wall and the pair of lateral walls being coupled to and extending rearwardly from the front wall, the top wall being coupled to and extending between the pair of lateral walls, the enclosure having a cavity defined by the front wall, the top wall, and the pair of lateral walls;
an outlet bracket coupled to the enclosure, the outlet bracket being positioned in the cavity of the enclosure, the outlet bracket comprising a back panel which extends between the pair of lateral walls of the enclosure, the back panel having a mounting hole extending therethrough, the mounting hole being positioned to facilitate mounting the outlet bracket to an electrical outlet via an outlet-mounting threaded fastener extending through the mounting hole of the back plate and an outlet mount hole of the electrical outlet; and
wherein the outlet bracket is positioned relative to a bottom of the enclosure such that the bottom of the enclosure is configured to retain a portion of an electrical cord plugged into the electrical outlet adjacent to a floor surface when the outlet bracket is mounted to the electrical outlet.

2. The electrical outlet covering apparatus of claim 1, wherein the back panel has a pair of outlet access holes extending therethrough, each outlet access hole of the pair of outlet access holes being positioned and configured to align with an associated receptacle of a pair of receptacles of the electrical outlet.

3. The electrical outlet covering apparatus of claim 2, wherein the mounting hole being positioned between the pair of outlet access holes.

4. The electrical outlet covering apparatus of claim 1, wherein:
a position of the outlet bracket is adjustable between a top of the enclosure and the bottom of the enclosure; and
the outlet bracket is couplable in a position relative to the bottom of the enclosure such that the bottom of the enclosure is configured to retain a portion of an electrical cord plugged into the electrical outlet adjacent to a floor surface when the outlet bracket is mounted to the electrical outlet.

5. The electrical outlet covering apparatus of claim 4, wherein:
each lateral wall of the pair of lateral walls has a plurality of height adjustment slots extending therethrough, the plurality of height adjustment slots of each lateral wall being spaced from each other between a top of the enclosure and the bottom of the enclosure;
the outlet bracket further comprising a pair of lateral members coupled to the back plate, the pair of lateral members being positioned opposite each other across the mounting hole, each lateral member of the pair of lateral members being coupled to an associated lateral wall of the pair of lateral walls of the enclosure, each lateral member of the pair of lateral members having a fastener slot extending through an outer surface of the lateral member, the fastener slot of each lateral member being positionable to interchangeably align with each height adjustment slot of the associated lateral wall of the enclosure; and
further comprising a pair of height adjustment fasteners removably coupled to the outlet bracket and the enclosure, each height adjustment fastener of the pair of height adjustment fasteners extending through a selected height adjustment slot of an associated lateral wall of the pair of lateral walls of the enclosure and the fastener slot of an associated lateral member of the pair of lateral members of the outlet bracket.

6. The electrical outlet covering apparatus of claim 5, wherein each height adjustment fastener of the pair of adjustment fasteners comprises a bracket-positioning threaded fastener.

7. The electrical outlet covering apparatus of claim 1, wherein each lateral wall of the pair of lateral walls has a notch at a corner of a bottom edge and a back edge of the lateral wall, the notch of each lateral wall being sized and shaped to accommodate a baseboard.

8. The electrical outlet covering apparatus of claim 1, further comprising a decorative element coupled to an exterior of the enclosure, the decorative element covering an entirety of the exterior of the enclosure.

9. An electrical outlet covering apparatus comprising:
an enclosure having a front wall, a top wall, and a pair of lateral walls, the top wall and the pair of lateral walls being coupled to and extending rearwardly from the front wall, the top wall being coupled to and extending between the pair of lateral walls, the enclosure having a cavity defined by the front wall, the top wall, and the pair of lateral walls, each lateral wall of the pair of lateral walls having a plurality of height adjustment slots extending therethrough, the plurality of height adjustment slots of each lateral wall being spaced from each other between a top of the enclosure and a bottom of the enclosure, each lateral wall of the pair of lateral walls having a notch at a corner of a bottom edge and a back edge of the lateral wall, the notch of each lateral wall being sized and shaped to accommodate a baseboard;
an outlet bracket coupled to the enclosure, the outlet bracket being positioned in the cavity of the enclosure, the outlet bracket comprising a back panel which extends between the pair of lateral walls of the enclosure, the back panel having a mounting hole extending therethrough, the mounting hole being positioned to facilitate mounting the outlet bracket to an electrical outlet via an outlet-mounting threaded fastener extending through the mounting hole of the back plate and an outlet mount hole of the electrical outlet, the back panel having a pair of outlet access holes extending therethrough, each outlet access hole of the pair of outlet access holes being positioned and configured to align with an associated receptacle of a pair of receptacles of the electrical outlet, the mounting hole being positioned between the pair of outlet access holes, the outlet bracket further comprising a pair of lateral members coupled to the back plate, the pair of lateral members being positioned opposite each other across the mounting hole, each lateral member of the pair of lateral members being coupled to an associated lateral wall of the pair of lateral walls of the enclosure, each lateral member of the pair of lateral members having a fastener slot extending through an outer surface of the lateral member, the fastener slot of each lateral member being positionable to interchangeably align with each height adjustment slot of the associated lateral wall of the enclosure;
a pair of height adjustment fasteners removably coupled to the outlet bracket and the enclosure, each height adjustment fastener of the pair of height adjustment fasteners extending through a selected height adjustment slot of an associated lateral wall of the pair of lateral walls of the enclosure and the fastener slot of an associated lateral member of the pair of lateral members of the outlet bracket, each height adjustment fastener of the pair of adjustment fasteners comprising a bracket-positioning threaded fastener;
wherein the outlet bracket is couplable in a position relative to the bottom of the enclosure such that the bottom of the enclosure is configured to retain a portion of an electrical cord plugged into the electrical outlet adjacent to a floor surface when the outlet bracket is mounted to the electrical outlet; and
a decorative element coupled to an exterior of the enclosure, the decorative element covering an entirety of the exterior of the enclosure.
